(19) United States
(12) Patent Application Publication
(10) Pub. No.: US 2024/0055599 A1
(43) Pub. Date: Feb. 15, 2024

(54) BATTERY CELL AND MODULE AGING

(71) Applicant: Ford Global Technologies, LLC, Dearborn, MI (US)

(72) Inventors: Kyungjin Park, Northville, MI (US); Brian Utley, Canton, MI (US); Mary Frederick, Carleton, MI (US); Daewon Han, New Hudson, MI (US); Chi Paik, Grosse Ile, MI (US)

(21) Appl. No.: 17/886,898

(22) Filed: Aug. 12, 2022

(51) Int. Cl. H01M 4/58; H01M 10/0525; H01M 4/04

(52) U.S. Cl. CPC H01M 4/58; H01M 10/0525; H01M 4/0404; H01M 2004/028

(57) ABSTRACT

A positive electrode for a lithium-ion battery includes a current collector a positive electrode active layer disposed over the current collector. The positive electrode active layer is composed of a positive electrode composition includes a first positive electrode active material that has been aged for a first predetermined time period.

### TECHNICAL FIELD

In at least one aspect, lithium-ion battery cells that utilized aged electrode active materials are provided.

### BACKGROUND

As lithium-ion batteries (LIB) progress toward higher energy densities, thermal runaway can increase due to the high energies of active materials. Accordingly, there is a need for new lithium-ion battery electrode compositions that addresses thermal runaway.

### SUMMARY

In at least one aspect, a positive electrode for a lithium-ion battery is provided. The positive electrode includes a current collector and a positive electrode active layer disposed over the current collector. The positive electrode active layer is composed of a positive electrode composition that includes a first positive electrode active material that has been aged for a first predetermined time period.

In another aspect, a positive electrode for a lithium-ion battery is provided. The positive electrode includes a current collector and a positive electrode active layer disposed over the current collector. The positive electrode active layer is composed of a positive electrode composition that includes a first positive electrode active material that has been aged for a first predetermined time period intermixed with a second positive electrode active material that has been aged for a second predetermined time period. Characteristically, the first predetermined time period is greater than the second predetermined time period.

In another aspect, a method for forming a positive electrode for a lithium-ion battery is provided. The method utilizes a longer formation step than normal to intentionally age a lithium-ion battery cell at optimal conditions that preserve the cell performance. The utilization of aged active materials allows the cell passivity to delay thermal response to abusive conditions (e.g, high temperature, voltage, and excess current), as well as lowering the severity of thermal response.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A. Schematic cross-section of an electrode using aged electrode active materials and coated on one side of a current collector.

FIG. 1B. Schematic cross-section of an electrode using aged electrode active material and coated on both sides of a current collector.

FIG. 2. Schematic cross-section of a battery cell incorporating the electrode of FIG. 1A.

FIG. 3. Schematic cross-section of a battery incorporating the battery cell of FIG. 2.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

The term “positive electrode” means a battery cell electrode from which current flows out when the lithium-ion battery cell or battery is discharged. Sometimes a “positive electrode” is referred to as a “cathode.”

The term “negative electrode” means a battery cell electrode to which current flows in when the lithium-ion battery cell is discharged. Sometimes a “negative electrode” is referred to as an “anode.”

The term “cell” or “battery cell” means an electrochemical cell made of at least one positive electrode, at least one negative electrode, an electrolyte, and a separator membrane.

The term “battery” or “battery pack” means an electric storage device made of at least one battery cell. In a refinement, “battery” or “battery pack” is an electric storage device made of a plurality of battery cells.

Abbreviations:
“BEV” means battery electric vehicle.
“LCO” means lithium cobalt oxide.
“NCMA” means nickel cobalt manganese aluminum quaternary material.
“NCA” means nickel cobalt aluminum ternary material.
“LFP” means lithium iron phosphate.
“LMP” means lithium manganese phosphate.
“LVP” means lithium vanadium phosphate.
“LMO” means lithium manganate.

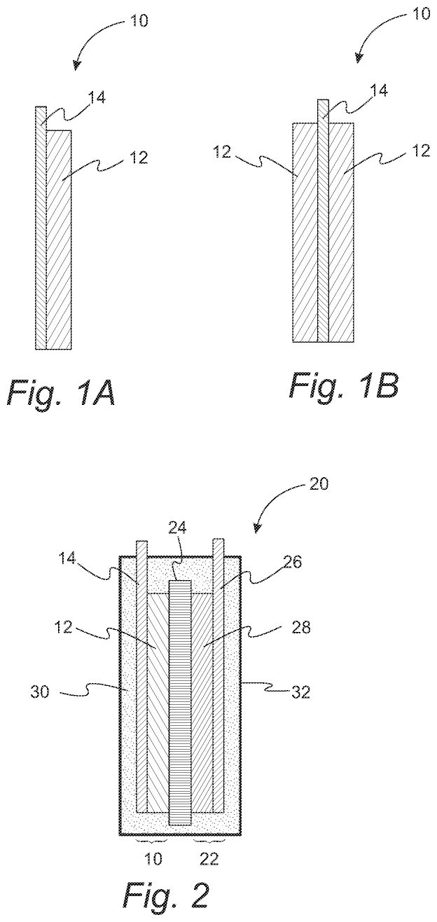

Referring to FIGS. 1A and 1B, positive electrodes for a lithium-ion battery are schematically illustrated. The positive electrode 10 includes a positive electrode active layer 12 disposed over, and optionally contacting, a current collector 14. Positive electrode active layer 12 is composed of a positive electrode composition that includes a first positive electrode active material that has been aged for a first predetermined time period. FIG. 1A depicts the positive electrode active material coated onto a single face (i.e., side) of the current collector while FIG. 1B depicts the positive electrode active material coated onto opposite faces (i.e., sides) of the current collector.

In a variation, the positive electrode active layer 12 further includes a second positive electrode material that has been aged for a second predetermined time period where the second predetermined time period is greater than the first predetermined time period. Advantageously, the first positive electrode active material can be intermixed with the second positive electrode active material. In a refinement, the positive electrode active layer 12 includes additional positive electrode materials that are aged for predetermined time periods that are different than the first predetermined time period and the second predetermined time period. The first predetermined time period and the second predetermined time period can be greater than or equal to 1 hour, 2 hours, 5 hours, 10 hours, 1 day, 2 days, 5 days, or 10 days. In a refinement, the first predetermined time period and the second predetermined time period can be less than or equal to 20 days, 15 days, 10 days, 5 days, or 1 day.

The first positive electrode material and the second positive electrode material (and any additional positive electrode material used herein) can be any material known in the art that is used as a primary electrode material for lithium-ion batteries. Suitable positive electrode materials include but are not limited to lithium manganese-doped iron phosphate (LMFP), nickel cobalt manganese ternary material (NCM), nickel cobalt aluminum ternary material (NCA), nickel cobalt manganese aluminum quaternary material (NCMA), or combinations thereof. In a refinement, the first positive electrode active material is ultra-fine lithium manganese-doped iron phosphate (LMFP) and the second positive electrode active material is nickel cobalt manganese (NCM). In a refinement, the suitable positive electrode materials have a particle size from about 10 to 150 nm. In a refinement, the suitable positive electrode materials have a particle size from about 30 to 100 nm.

In a variation, the first positive electrode active material and the second positive electrode active material if present are each independently aged during formation thereof by exposure to temperatures greater than 40° C. In a refinement, the positive electrode active material and the second positive electrode active material are each independently aged during formation thereof by exposure to temperatures from 45 to 60° C. In another refinement, the positive electrode active material and the second positive electrode active materials can be grown under optimal growth conditions forming a film with a 1 to 100 nm film at 45 to 60° C.

In still another variation, the first and second positive electrode active materials are aged by cycling the positive electrode for at least one charging cycle. For example, the at least one charging cycle can be performed at 3 to 5 V (e.g., 3.2 to 4.1 V) with a charge rate of C/20 or higher. In a refinement, the first and/or second positive electrode active materials are aged by cycling the positive electrode for at least 1, 2, 5, 20, 200, 1000, or 5000 charging cycles. In a further refinement, the first and/or second positive electrode active materials are aged by cycling the positive electrode for at most 2000, 10000, 5000, 1000, 500, 200, 100, or 50 charging cycles.

In another variation, the first positive electrode active material and the second positive electrode active material if present are each independently aged in the presence of an electrolyte that includes a passivating agent to establish a robust passive film that functions as a protective ‘thermal blanket,’ at the same time as an effective Li+ ion conductor. In a refinement, the passivating agent is a vinylene carbonate such as ethylene carbonate.

Advantageously, the aging processes set forth herein can be performed at a module level for higher throughput efficiency. In a refinement, the aging processes can be performed with cells under compression.

In a variation, the positive electrode materials can be a high nickel content material (e.g., a high nickel NCM) having nickel in an about greater than or equal to 35 weight percent to about 75 weight percent of the total weight of the first and/or second positive electrode material. The first and/or second positive electrode materials (e.g., high nickel NCM) include nickel in an amount from about 35 weight percent to about 75 weight percent of the total weight of the first and/or second positive electrode materials, respectively. In some refinements, the first positive electrode and/or second positive materials include nickel in an amount of at least 30 weight percent, 35 weight percent, 40 weight percent, 45 weight percent, 50 weight percent, or 55 weight percent of the total weight of the first and/or second positive electrode materials, respectively and at most in increasing order of preference 99 weight percent, 95 weight percent, 90 weight percent, 85 weight percent, 80 weight percent, or 70 weight percent of the total weight of the first and/or second positive electrode material, respectively.

With reference to FIG. 2, a schematic of a rechargeable lithium-ion battery cell incorporating the positive electrode of FIG. 1 is provided. Battery cell 20 includes positive electrode 10, negative electrode 22, and separator 24 interposed between the positive electrode and the negative electrode. Positive electrode 10 includes a positive electrode current collector 14 and positive electrode active layer 12 disposed over the positive electrode current collector. Typically, positive electrode current collector 14 is a metal plate or metal foil composed of a metal such as aluminum, copper, platinum, zinc, titanium, and the like. Currently, aluminum is most commonly used for the negative electrode current collector. Similarly, negative electrode 22 includes a negative electrode current collector 26 and a negative active material layer 28 disposed over and typically contacting the negative current collector. Typically, negative electrode current collector 26 is a metal plate or metal foil composed of a metal such as aluminum, copper, platinum, zinc, titanium, and the like. Currently, copper is most commonly used for the negative electrode current collector. The battery cell is immersed in electrolyte 30 which is enclosed by battery cell case 32. Electrolyte 30 imbibes into separator 24. In other words, the separator 24 includes the electrolyte thereby allowing lithium ions to move between the negative and positive electrodes. The electrolyte includes a non-aqueous organic solvent and a lithium salt. The non-aqueous organic solvent serves as a medium for transmitting ions taking part in the electrochemical reaction of a battery.

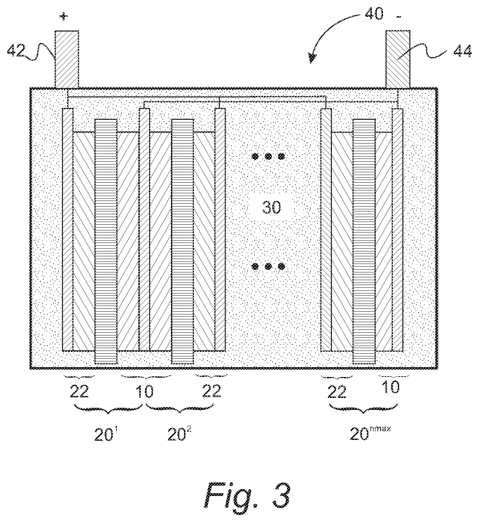

With reference to FIG. 3, a schematic of a rechargeable lithium-ion battery incorporating the positive electrode of FIG. 1 and the battery cells of FIG. 2 is provided. Rechargeable lithium-ion battery 40 includes at least one battery cell of the design in FIG. 2. Typically, rechargeable lithium-ion battery 40 includes a plurality of battery cells 20′ of the design of FIG. 2 where i is an integer label for each battery cell. The label i runs from 1 to nmax, where nmax is the total number of battery cells in rechargeable lithium-ion battery 40. Each lithium-ion battery cell 20′ includes a positive electrode 10 which includes a positive electrode active material, a negative electrode 22 which includes a negative active material, and an electrolyte 30, The electrolyte includes a non-aqueous organic solvent and a lithium salt. The non-aqueous organic solvent serves as a medium for transmitting ions taking part in the electrochemical reaction of a battery. The plurality of battery cells can be wired in series, in parallel, or a combination thereof. The voltage output from battery 40 is provided across terminals 42 and 44.

Referring to FIGS. 2 and 3, separator 24 physically separates the negative electrode 22 from the positive electrode 10 thereby preventing shorting while allowing the transport of lithium ions for charging and discharging. Therefore, separator 24 can be composed of any material suitable for this purpose. Examples of suitable materials from which separator 24 can be composed include but are not limited to, polytetrafluoroethylene (e.g., TEFLON®), glass fiber, polyester, polyethylene, polypropylene, and combinations thereof. Separator 24 can be in the form of either a woven or non-woven fabric. Separator 24 can be in the form of a non-woven fabric or a woven fabric. For example, a polyolefin-based polymer separator such as polyethylene and/or polypropylene is typically used for a lithium-ion battery. In order to ensure heat resistance or mechanical strength, a coated separator includes a coating of ceramic or a polymer material may be used.

Referring to FIGS. 2 and 3, electrolyte 30 includes a lithium salt dissolved in a non-aqueous organic solvent. Therefore, electrolyte 30 includes lithium ions that can intercalate into the positive electrode active material during charging and into the anode active material during discharging. Examples of lithium salts include but are not limited to LiPF₆, LiBF₄, LiSbF₆, LiAsF₆, LiC₄F₉SO₃, LiClO₄, LiAlO₂, LiAlCl₄, LiCl, LiI, LiB(C₂O₄)₂, and combinations thereof. In a refinement, the electrolyte includes the lithium salt in an amount from about 0.1 M to about 2.0 M.

Still referring to FIGS. 2 and 3, the electrolyte includes a non-aqueous organic solvent and a lithium salt. Advantageously, the non-aqueous organic solvent serves as a medium for transmitting ions, and in particular, lithium ions participate in the electrochemical reaction of a battery. Suitable non-aqueous organic solvents include carbonate-based solvents, ester-based solvents, ether-based solvents, ketone-based solvents, alcohol-based solvents, aprotic solvents, and combinations thereof. Examples of carbonate-based solvents include but are not limited to dimethyl carbonate, diethyl carbonate, dipropyl carbonate, methylpropyl carbonate, ethylpropyl carbonate, methylethyl carbonate, ethylene carbonate, propylene carbonate, butylene carbonate, and combinations thereof. Examples of ester-based solvents include but are not limited to methyl acetate, ethyl acetate, n-propyl acetate, methylpropionate, ethylpropionate, γ-butyrolactone, decanolide, valerolactone, mevalonolactone, caprolactone, and combinations thereof. Examples of ether-based solvents include but are not limited to dibutyl ether, tetraglyme, diglyme, dimethoxyethane, 2-methyltetrahydrofuran, tetrahydrofuran, and the like, and the ketone-based solvent may include cyclohexanone, and the like. Examples of alcohol-based solvent include but are not limited to methanol, ethyl alcohol, n-propyl alcohol, isopropyl alcohol, and the like. Examples of the aprotic solvent include but are not limited to nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, sulfolanes, and the like. Advantageously, the non-aqueous organic solvent can be used singularly. In other variations, mixtures of the non-aqueous organic solvent can be used. Such mixtures are typically formulated to optimize battery performance. In a refinement, a carbonate-based solvent is prepared by mixing a cyclic carbonate and a linear carbonate. In a variation, electrolyte 30 can further include vinylene carbonate or an ethylene carbonate-based compound to increases battery cycle life.

Referring to FIGS. 1, 2, and 3, the negative electrode and the positive electrode can be fabricated by methods known to those skilled in the art of lithium-ion batteries. Typically, an active material (e.g., the positive or negative active material) is mixed with a conductive material, and a binder in a solvent (e.g., N-methylpyrrolidone) into an active material composition and coating the composition on a current collector. The electrode manufacturing method is well known and thus is not described in detail in the present specification. The solvent includes N-methylpyrrolidone and the like but is not limited thereto.

Referring to FIGS. 1, 2, and 3, the positive electrode active material layer 12 includes positive electrode active material, a binder, and a conductive material. The positive electrode active materials used herein can be those positive electrode materials known to one skilled in the art of lithium-ion batteries. In particular, the positive electrode 10 may be formed from a lithium-based active material that can sufficiently undergo lithium intercalation and deintercalation. The positive electrode 10 active materials may include one or more transition metals, such as manganese (Mn), nickel (Ni), cobalt (Co), chromium (Cr), iron (Fe), vanadium (V), and combinations thereof. Common classes of positive electrode active materials include lithium transition metal oxides with layered structure and lithium transition metal oxides with spinel phase. Examples of lithium transition metal oxides with layered structure include, but are not limited to lithium cobalt oxide (LiCoO₂), lithium nickel oxide (LiNiO₂), a lithium nickel manganese cobalt oxide (e.g., Li(NiₓMnyCo_{z})O₂), where 0≤x≤1, 0≤y≤1, 0≤z≤1, and x+y+z=1), a lithium nickel cobalt metal oxide (e.g., LiNi_{(1-x-y)}CoₓMyO₂), where 0<x<1, 0<y<1 and M is Al, Mn). Other known lithium-transition metal compounds such as lithium iron phosphate (LiFePO₄) or lithium iron fluorophosphate (Li₂FePO₄F) can also be used. In certain aspects, the positive electrode 10 may include an electroactive material that includes manganese, such lithium manganese oxide (Li₍₁₊ₓ₎Mn₍₂₋ₓ₎O₄), a mixed lithium manganese nickel oxide (LiMn₍₂₋ₓ₎NiₓO₄), where 0≤x≤1, and/or a lithium manganese nickel cobalt oxide. Additional examples of positive electrode active materials include but are not limited to lithium manganese-doped iron phosphate (LMFP), nickel cobalt manganese ternary material (NCM), nickel cobalt aluminum ternary material (NCA), nickel cobalt manganese aluminum quaternary material (NCMA), or combinations thereof. In a refinement, the first positive electrode active material is ultra-fine lithium manganese-doped iron phosphate (LMFP) and the second positive electrode active material is nickel cobalt manganese (NCM). Each of the positive electrode active material described herein can be aged as set forth above.

The binder for the positive electrode active material can increase the binding properties of positive electrode active material particles with one another and with the positive electrode current collector 14. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, and the like.

Referring to FIGS. 1, 2, and 3, the negative active material layer 26 includes a negative active material, includes a binder, and optionally a conductive material. The negative active materials used herein can be those negative materials known to one skilled in the art of lithium-ion batteries. Negative active materials include but are not limited to, carbon-based negative active materials, silicon-based negative active materials, and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide can be described by the formula SiO_{z} where z is from 0.09 to 1.1. Mixtures of carbon-based negative active materials, silicon-based negative active materials can also be used for the negative active material.

The negative electrode binder increases the binding properties of negative active material particles with one another and with a current collector. The binder can be a non-aqueous binder, an aqueous binder, or a combination thereof. Examples of non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A positive electrode for a lithium-ion battery comprising:
a current collector; and
a positive electrode active layer disposed over the current collector, the positive electrode active layer is composed of a positive electrode composition including a first positive electrode active material that has been aged for a first predetermined time period.

2. The positive electrode of claim 1, wherein the first positive electrode active material includes a component selected from the group consisting of lithium manganese-doped iron phosphate (LMFP), nickel cobalt manganese ternary material (NCM), nickel cobalt aluminum ternary material (NCA), nickel cobalt manganese aluminum quaternary material (NCMA), or combinations thereof.

3. The positive electrode of claim 1, wherein the first positive electrode active material has a particle size from about 10 to 150 nm.

4. The positive electrode of claim 1, wherein the first positive electrode active material includes nickel in an amount greater than or equal to 35 weight percent of the total weight of the first positive electrode active material.

5. The positive electrode of claim 1, wherein the positive electrode active layer further includes a second positive electrode material that is aged for a second predetermined time period wherein the second predetermined time period is greater than the first predetermined time period.

6. The positive electrode of claim 5, wherein the first positive electrode active material is intermixed with the second positive electrode active material.

7. The positive electrode of claim 6, wherein the first positive electrode active material is ultra-fine lithium manganese-doped iron phosphate (LMFP) and the second positive electrode active material is nickel cobalt manganese (NCM).

8. The positive electrode of claim 6, wherein the first positive electrode active material and the second positive electrode active material are each independently aged during formation thereof by exposure to temperatures greater than 40° C.

9. The positive electrode of claim 6, wherein the first positive electrode active material and/or the second positive electrode active material are each independently aged in the presence of an electrolyte that includes a passivating agent.

10. The positive electrode of claim 9, wherein the passivating agent is a vinylene carbonate.

11. The positive electrode of claim 6, wherein the first positive electrode active material and the second positive electrode active material are each independently aged during formation thereof by exposure to temperatures from 45 to 60° C.

12. The positive electrode of claim 1, wherein the positive electrode composition is aged by cycling the positive electrode for at least one charging cycle.

13. The positive electrode of claim 12, wherein the at least one charging cycle is performed at 3.2 to 4.1 V with a charge rate of C/20 or higher.

14. The positive electrode of claim 1, wherein aging is performed at a module level for higher throughput efficiency and/or under compression.

15. A positive electrode for a lithium-ion battery comprising:
a current collector; and
a positive electrode active layer disposed over the current collector, the positive electrode active layer is composed of a positive electrode composition including a first positive electrode active material that has been aged for a first predetermined time period intermixed with a second positive electrode active material that has been aged for a second predetermined time period, wherein the first predetermined time period is greater than the second predetermined time period.

16. The positive electrode of claim 15, wherein the first positive electrode active material and the second positive electrode active material each independently include a component selected from the group consisting of lithium manganese-doped iron phosphate (LMFP), nickel cobalt manganese ternary material (NCM), nickel cobalt aluminum ternary, material (NCA), nickel cobalt manganese aluminum quaternary material (NCMA), or combinations thereof.

17. The positive electrode of claim 15, wherein the first positive electrode active material and the second positive electrode active material each independently have a particle size from about 10 to 150 nm.

18. The positive electrode of claim 15, wherein the first positive electrode active material is ultra-fine lithium manganese-doped iron phosphate (LMFP) and the second positive electrode active material is nickel cobalt manganese (NCM).

19. The positive electrode of claim 15, wherein the first positive electrode active material and/or the second positive electrode active material are each independently aged in the presence of an electrolyte that includes a passivating agent.

20. The positive electrode of claim 19, wherein the passivating agent is a vinylene carbonate.
